(19) United States
(12) Patent Application Publication
(10) Pub. No.: US 2010/0057525 A1
(43) Pub. Date: Mar. 4, 2010

(54) METHODS AND APPARATUS TO CALIBRATE A CHOICE FORECASTING SYSTEM FOR USE IN MARKET SHARE FORECASTING

(76) Inventors: John Gerard Wagner, Covington, KY (US); William Kelly Zimmerman, Hamilton, OH (US)

Correspondence Address: Hanley, Flight & Zimmerman, LLC, 150 S. Wacker Dr. Suite 2100, Chicago, IL, 60606, US

(21) Appl. No.: 12/199,336

(22) Filed: Aug. 27, 2008

(51) Int. Cl. G06F 17/30

(52) U.S. Cl. 705/10; 705/7

(57) ABSTRACT

Methods and apparatus to calibrate a choice forecasting system for use in market share forecasting are disclosed. An example disclosed method comprises obtaining market research data to determine a plurality of choice probabilities and a plurality of segment weights, each choice probability representing a probability that a respective population segment will choose a respective alternative from a plurality of alternatives and each segment weight representing a weight of a respective population segment in an overall population, and performing a calibration procedure to calibrate the plurality of choice probabilities and plurality of segment weights, the calibration procedure configured to preserve before and after calibration relative contributions of a pair of population segments to a first choice share corresponding to a first alternative, the first choice share for the first alternative determinable from the plurality of segment weights and a subset of the plurality of choice probabilities corresponding to the first alternative.

### FIELD OF THE DISCLOSURE

This disclosure relates generally to market share forecasting and, more particularly, to methods and apparatus to calibrate a choice forecasting system for use in market share forecasting.

### BACKGROUND

Market share modeling and associated market share forecasting systems are becoming increasingly popular tools for product and service portfolio management. For example, a market share forecasting system may be used to predict market response to proposed products and/or services and, thus, can be especially useful for planning launches of new products and/or services. A typical market share forecasting system forecasts or, in other words, predicts a potential market share for one or more new and/or existing products and/or services using a variety of constituent forecasts.

One type of constituent forecast employed in at least some example market share forecasting systems is a choice forecast that is determined by choice modeling and/or an associated choice forecasting system. Some example choice forecasting systems operate on available market research data using one or more choice forecasting models to forecast choices individuals and/or groups of individuals (e.g., segments of the population) will make in response to a stimulus (e.g., the introduction of a new product and/or service). Typically, the choices undergoing forecasting involve making one or more selections from a set of alternatives, such as a set of alternative products, a set of alternative services, etc.

### BRIEF DESCRIPTION OF THE DRAWINGS

FIG. 1 is a block diagram of an example market research forecasting system and a corresponding example environment of use.

FIG. 2 is a block diagram of an example choice forecasting system that may be used in the example market research forecasting system of FIG. 1.

FIG. 3 is a block diagram of an example choice forecasting calibration unit that may be used in the example choice forecasting systems of FIGS. 1 and/or 2.

FIG. 4 is a flowchart representative of example machine readable instructions to perform choice forecasting calibration that may be executed to implement the example choice forecasting calibration unit of FIG. 3.

FIG. 5 is a flowchart representative of example machine readable instructions to perform choice probability calibration that may be used to implement the example machine readable instructions of FIG. 4 and/or executed to implement the example choice forecasting calibration unit of FIG. 3.

FIG. 6 is a flowchart representative of example machine readable instructions to perform choice probability scaling that may be used to implement the example machine readable instructions of FIG. 5 and/or executed to implement the example choice forecasting calibration unit of FIG. 3.

FIG. 7 is a flowchart representative of example machine readable instructions to perform choice probability normalization that may be used to implement the example machine readable instructions of FIG. 5 and/or executed to implement the example choice forecasting calibration unit of FIG. 3.

FIG. 8 is a flowchart representative of example machine readable instructions to perform segment weight calibration that may be used to implement the example machine readable instructions of FIG. 4 and/or executed to implement the example choice forecasting calibration unit of FIG. 3.

FIG. 9 is a block diagram illustrating an example operation of the example choice forecasting system of FIG. 2.

FIG. 10 is a block diagram representative of example machine readable instructions to perform an integrated choice forecasting calibration procedure that may be executed to implement the example choice forecasting calibration unit of FIG. 3.

FIG. 11 is a block diagram of an example computer that may execute the example machine readable instructions of FIGS. 4-8 and/or 10 to implement the example choice forecasting calibration unit of FIG. 3.

### DETAILED DESCRIPTION

An example market share forecasting system may employ an example choice forecasting system to forecast or, in other words, predict choices (e.g., selections of products and/or services) to be made by segments of the population (e.g., individuals and/or groups of individuals) from a set of alternatives (e.g., a set of alternative products and/or services). Methods and apparatus to calibrate at least some of these example choice forecasting systems are disclosed herein. In an example method described herein to calibrate an example automated choice forecasting system, an example choice forecasting calibration unit performs an automated calibration procedure to calibrate choice probabilities and segment weights for use in the example automated choice forecasting system. In an example implementation, each choice probability represents a probability that a respective population segment will choose a respective alternative from a set of alternatives, and each segment weight represents a weight of a respective population segment in an overall population.

As described in greater detail below, the automated calibration procedure in at least some example implementations is configured to preserve before and after calibration certain relationships among the choice probabilities and segment weights. Additionally, in at least some example methods described herein to calibrate an example automated choice forecasting system, the example choice forecasting calibration unit stores the calibrated choice probabilities and the calibrated segment weights for use by an associated example choice forecasting system that uses the calibrated choice probabilities and the calibrated segment weights to generate and output a choice forecast. The outputted choice forecast can be used in a variety of applications, such as, but not limited to, being used to determine whether to commence, halt or modify a new product or new service launch into the marketplace.

In at least some operating scenarios, such example calibration methods and apparatus can improve accuracy, consistency, reliability, etc., of the example choice forecasting system without altering the underlying model(s) used to make the choice forecasts. For example, before using a choice forecasting system to determine forecast(s) of future choice(s) that will be made by population segment(s), an example calibration method and/or apparatus as described herein may be used to calibrate the choice forecasting system to yield accurate “forecast(s)” of past choice(s) already made by the population segment(s). Such past choices may be determined from available market research data indicating what choices particular population segments have already made. The resulting choice forecasts may be compared to the actual choices to determine the differences therebetween. After the choice forecasting system has been calibrated to yield “forecast(s)” of past choice(s) that concur with available market research data, it is more likely that the choice forecasting system will yield accurate, consistent, reliable, etc., forecasts of future choices, at least in some operating scenarios,

At least some prior choice modeling techniques teach against calibration out of concern that calibration could, for example, disturb one or more underlying relationships between model parameters as estimated, for example, from available market research data. The calibration methods and apparatus described herein, however, operate to preserve certain parameter relationships before and after calibration. For example, the calibration methods and apparatus described herein may operate to preserve before and after calibration a relative contribution of a pair of population segments to each choice share corresponding to each possible alternative that can be chosen. In such an example implementation, a particular choice share may represent the probability (or likelihood) that the entire population (or some subset) will choose the particular alternative corresponding to the choice share. Additionally, as discussed in greater detail below, a particular choice share is determinable from the segment weights and a subset of the choice probabilities corresponding to the particular alternative represented by the particular choice share. Thus, by operating to preserve a relative contribution of a pair of population segments to each choice share, the example calibration methods and apparatus described herein may, at least in some scenarios, also preserve at least some underlying relationships between the segment weights and choice probabilities used in the example choice forecasting system undergoing calibration.

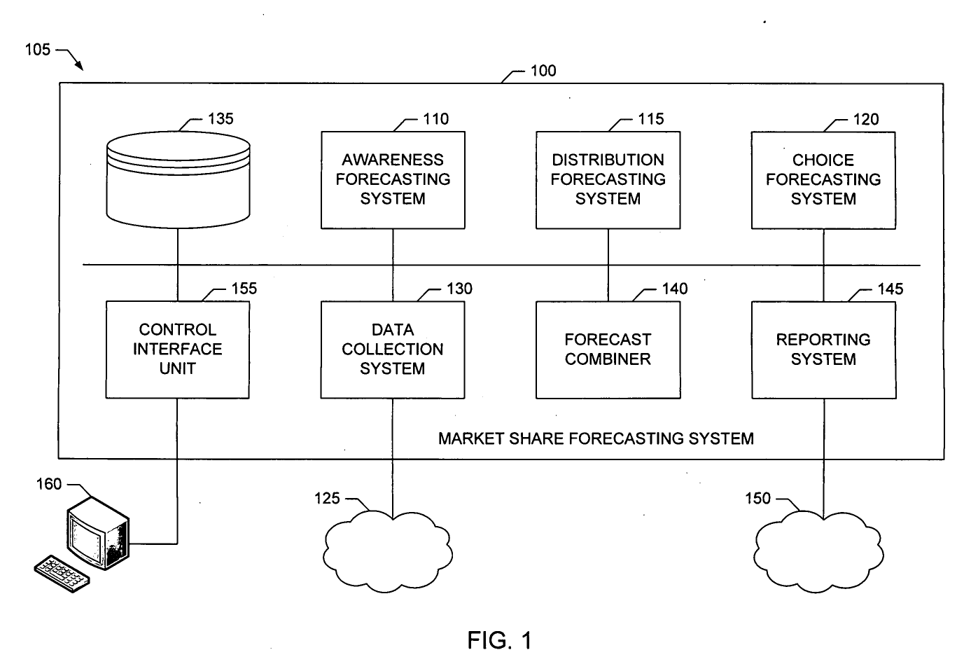

Turning to the figures, a block diagram of an example automated market research forecasting system 100 and a corresponding example environment of use 105 are illustrated in FIG. 1. The market research forecasting system 100 of the illustrated example operates to forecast potential market shares for new and/or existing products and/or services. As described above, such market share forecasts may be used for management of product and/or service portfolios, and may be especially beneficial in planning launches of new products and/or new services.

The example market research forecasting system 100 determines potential market share forecasts by combining a variety of constituent forecasts determined by a corresponding group of constituent forecasting systems. In the illustrated example of FIG. 1, the constituent forecasting systems implementing the example market research forecasting system 100 include an automated awareness forecasting system 110, an automated distribution forecasting system 115 and an automated choice forecasting system 120. However, although the example of FIG. 1 illustrates a particular group of constituent forecasting systems 110, 115 and 120, other groups of constituent forecasting systems may alternatively be used to implement the example market research forecasting system 100.

In the illustrated example, the awareness forecasting system 110, the distribution forecasting system 115 and the choice forecasting system 120 determine their respective constituent forecasts based on market research data obtained from one or more market research data sources 125 included in the example environment of use 105. The market research data source(s) 125 may include, for example, consumer behavior data generated in response to customer interviews, market research surveys, etc., which may be computerized and/or conducted in-person. Additionally or alternatively, the market research data source(s) 125 may include consumer purchasing data generated from diaries and/or automated scanning equipment (e.g., such as bar code scanners, radio frequency identification (RFID) scanners, etc.) employed by members of a market research panel, point-of-sale data provided by retailers, wholesalers, etc., as well any other types of data indicative of consumer purchasing behavior.

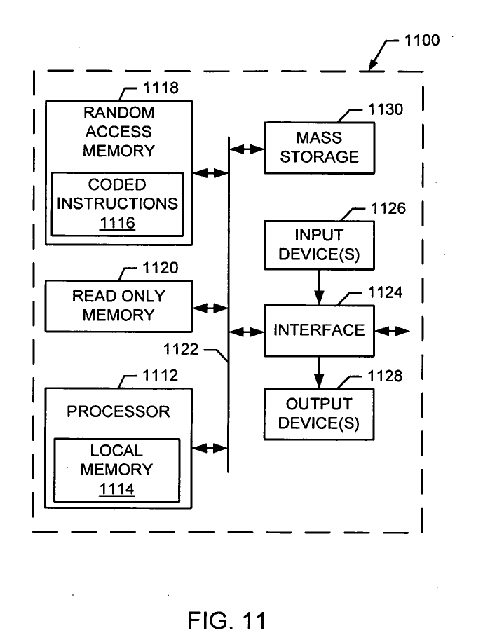

The example market research forecasting system 100 includes a data collection system 130 to collect the data (e.g., via automated and/or manual processing) from the market research data source(s) 125 for storage in a storage unit 135. The example storage unit 135 may be implemented by any type of storage unit, memory device, memory element, database, etc., such as the example mass storage device 1130 and/or the example volatile memory 1118 of the example computer system 1100 illustrated in FIG. 11 and discussed in greater detail below.

Turning to the constituent forecasting systems, the example awareness forecasting system 110 included in the example market share forecasting system 100 operates to forecast consumer awareness of particular product(s) and/or service(s). In the illustrated example, the awareness forecasting system 110 uses any appropriate technique to forecast consumer awareness based on market research data stored in the example storage unit 135 indicative of consumer awareness of different products and/or services. For example, the awareness forecasting system 110 may retrieve market research data related to brand recognition, advertisement exposure, etc., as obtained via customer interviews, market research surveys, etc. Additionally or alternatively, the example awareness forecasting system 110 may retrieve market research data related to product placement (e.g., shelf level placement, end-cap placement, etc.), product and/or service bundling which may yield additional product/service awareness, etc., as obtained from retailers via interviews, surveys, etc.

The example distribution forecasting system 115 included in the example market share forecasting system 100 operates to forecast distribution (e.g., availability) of particular product(s) and/or service(s). In the illustrated example, the distribution forecasting system 115 uses any appropriate technique to forecast product/service distribution based on market research data stored in the example storage unit 135 indicative of distribution and/or availability of products and/or services in the marketplace. For example, the distribution forecasting system 115 may retrieve market research point-of-sale data representative of the availability and distribution of existing products and/or services across various retail sites. Additionally or alternatively, the example distribution forecasting system 115 may retrieve market research data related to projected product/service orders obtained from retailers via interviews, surveys, etc.

As mentioned above, the example choice forecasting system 120 included in the example market share forecasting system 100 operates to forecast or, in other words, predict choices (e.g., selections) to be made by segments of a population (e.g., individuals and/or groups of individuals) from a set of alternatives. The set of alternatives may include a set of alternative products and/or alternative services which may be selected for purchase by consumers in a consumer population. In the illustrated example, the choice forecasting system 120 outputs forecasts in the form of choice shares for particular alternatives in the set of possible alternatives. For example, a particular choice share corresponding to a particular alternative represents a weighted average of choice probabilities for the particular alternative across the entire consumer population. Alternatively, a particular choice share may be viewed as a probability that an individual selected randomly from the entire consumer population will choose (e.g., select) the particular alternative from the set of alternatives. Additionally or alternatively, choice shares may be forecasted for only individual population segments and/or groups of population segments, and/or for alternatives chosen (e.g., selected) from only a subset of the set of possible alternatives.

To determine choice shares for particular alternatives, the example choice forecasting system 120 divides the overall consumer population into population segments and determines a set of segment weights and a corresponding set of choice probabilities from which the choice shares may be calculated. As mentioned above, each choice probability represents a probability that a respective population segment will choose a respective alternative from a set of alternatives, and each segment weight represents a weight of a respective population segment in an overall population. In the illustrated example, the example choice forecasting system 120 initially determines the set of segment weights and the corresponding set of choice probabilities based on market research data stored in the example storage unit 135.

In at least example implementations, the choice forecasting system 120 may determine the set of segment weights by processing demographic information included in the stored market research data to divide the overall consumer population into demographic segments and to then assign a representative weight to each segment. For example, the choice forecasting system 120 may divide the consumer population into segments based on one or more demographic criteria, such as age, sex, race, income, household size, etc. Then, the example choice forecasting system 120 may weight each segment based on one or more factors associated with the segment's demographics, such as percentage of the consumer population included in the particular segment, the average or some other statistical measure of the purchasing power of the segment, etc. Additionally or alternatively, the choice forecasting system 120 may determine some or all of the segment weights by treating each individual in a representative consumer populating as being a population segment, with each population segment having equal weight.

Additionally, in at least some example implementations, the choice forecasting system 120 may determine the set of choice probabilities by determining various decision factors from the stored market research data that could impact a consumer's decision to choose one alternative over another. For example, the choice forecasting system 120 may process the market research data using any appropriate technique to determine a measure of each alternative's utility to each population segment. The resulting set of “utilities” represents the usefulness of each alternative to each population segment. For example, utilities may be determinable from market research data indicating a reported usefulness (e.g., based on a usefulness scale) of each product alternative, each service alternative, etc. Additionally or alternatively, utilities may be determinable from market research data indicating a reported usefulness (e.g., based on a usefulness scale) of different product and/or service attributes, with the utility of a particular product or service then being determinable from the utilities associated with its attributes.

Other decision factors that could impact a consumer's decision to choose one alternative over another and, therefore, which may be determined by the example choice forecasting system 120 include display sensitivities, price sensitivities, price reduction (e.g., coupon or price reduction tag) sensitivities, etc. Display sensitivities may be determined, for example, from market research data indicating how a display of a particular product alternative or service alternative affects each segment's selection (e.g., purchase) of that alternative. Price sensitivities may be determined, for example, from market research data indicating how a price of a particular product alternative or service alternative affects each segment's selection (e.g., purchase) of that alternative. Furthermore, price reduction sensitivities may be determined, for example, from market research data indicating how a price reduction (e.g., in the form of coupons, price reduction tags, rebates, etc.) affects each segment's selection (e.g., purchase) of that alternative.

The example choice forecasting system 120 then uses any appropriate technique to determine the set of choice probabilities from the various consumer decision factors determined from the stored market research data. For example, a multinomial logit model discussed in greater detail below may be used to determine the set of choice probabilities from the various consumer decision factors. Once the set of segment weights and the corresponding set of choice probabilities are determined, the example choice forecasting system 120 can use the determined segment weights and choice probabilities to determine choice forecasts in the form of choice shares representing (1) the weighted averages of choice probabilities for particular alternatives across the entire consumer population, and/or (2) the probability that an individual selected randomly from the overall population or a particular subset of the population will choose particular alternatives from the set or a particular subset of the possible alternatives.

To combine the constituent forecasts from the example awareness forecasting system 110, the example distribution forecasting system 115 and the example automated choice forecasting system 120 into corresponding potential market share forecasts, the market research forecasting system 100 of the illustrated example includes a forecast combiner 140. The example forecast combiner 140 uses any appropriate technique to combine consumer awareness forecasts, product/service distribution forecasts and choice forecasts into overall market share forecasts. For example, the forecast combiner 140 may employ weighted averaging and/or other statistical combining to determine the overall market share forecasts from the constituent consumer awareness forecasts, product/service distribution forecasts and choice forecasts.

The example market share forecasting system 100 further includes a reporting system 145 to report its market share forecast to one or more report recipients 150 included in the example environment of use 105. Additionally or alternatively, the example reporting system 145 may report the constituent consumer awareness forecasts, product/service distribution forecasts and/or choice forecasts (as well as other constituent forecasts, if available) to the example report recipients) 150. The example report recipient(s) 150 may be individuals, such as portfolio managers, product/service marketers, etc., and/or other automated systems, such as automated portfolio management systems, product/service marketing systems, etc. In the example environment of use 105, at least some of the example report recipients) 150 use the reported market share forecasts and/or constituent forecasts (e.g., such as the choice forecasts) to determine whether to commence, halt or modify launching of new products and/or new services. For example, a report recipient 150 may determine to commence a particular product/service launch if a reported market share forecast for the particular product/service meets a target market share, and may determine to halt the launch if the forecast does not meet the target market share. Other uses of the reported market share forecasts and/or constituent forecasts are also possible.

The market share forecasting system 100 of the illustrated example also includes a control interface unit 155 to support control (e.g., administration) of the market share forecasting system 100, as well as its various components. For example, a workstation 160 is provided in the example environment of use 105 to allow an administrator to interact with the example control interface unit 155. In an example implementation, the administrator is able to use the example workstation 160 to access the example control interface unit 155 to set one or more configuration parameters in the example awareness forecasting system 110, the example distribution forecasting system 115, the example automated choice forecasting system 120, the example data collection system 130, the example forecast combiner 140, the example reporting system 145 and/or the example control interface unit 155 itself. The example workstation 160 maybe implemented using any type of workstation, computer or computing device and may be coupled to the example control interface unit 155 via any type of network or data path.

While an example manner of implementing the example market share forecasting system 100 has been illustrated in FIG. 1, one or more of the elements, processes and/or devices illustrated in FIG. 1 may be combined, divided, re-arranged, omitted, eliminated and/or implemented in any other way. Further, the example awareness forecasting system 110, the example distribution forecasting system 115, the example automated choice forecasting system 120, the example data collection system 130, the example forecast combiner 140, the example reporting system 145, the example control interface unit 155 and/or, more generally, the example market share forecasting system 100 of FIG. 1 may be implemented by hardware, software, firmware and/or any combination of hardware, software and/or firmware. Thus, for example, any of the example awareness forecasting system 110, the example distribution forecasting system 115, the example automated choice forecasting system 120, the example data collection system 130, the example forecast combiner 140, the example reporting system 145, the example control interface unit 155 and/or, more generally, the example market share forecasting system 100 could be implemented by one or more circuit(s), programmable processor(s), application specific integrated circuit(s) (ASIC(s)), programmable logic device(s) (PLD(s)) and/or field programmable logic device(s) (FPLD(s)), etc. When any of the appended claims are read to cover a purely software and/or firmware implementation, at least one of the example market share forecasting system 100, the example awareness forecasting system 110, the example distribution forecasting system 115, the example automated choice forecasting system 120, the example data collection system 130, the example forecast combiner 140, the example reporting system 145 and/or the example control interface unit 155 are hereby expressly defined to include a tangible medium such as a memory, digital versatile disk (DVD), compact disk (CD), etc., storing such software and/or firmware. Further still, the example market share forecasting system 100 of FIG. 1 may include one or more elements, processes and/or devices in addition to, or instead of, those illustrated in FIG. 1, and/or may include more than one of any or all of the illustrated elements, processes and devices.

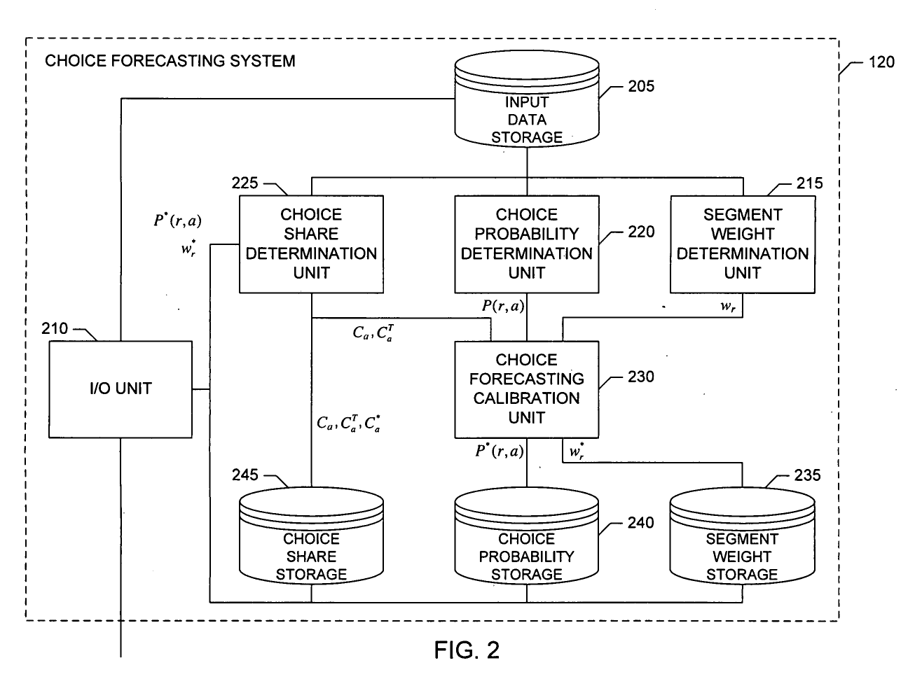

A block diagram of an example implementation of the choice forecasting system 120 of FIG. 1 is illustrated in FIG. 2. The example choice forecasting system 120 of FIG. 2 includes an input data storage unit 205 to store data received via an input/output (I/O) unit 210. For example, the input data storage unit 205 may store input market research data, configuration parameters, etc., for use in determining the segment weights, choice probabilities and choice shares discussed above in connection with FIG. 1. The example input data storage unit 205 may be implemented by any type of storage unit, memory device, memory element, database, etc., such as the example mass storage device 1130 and/or the example volatile memory 1118 of the example computer system 1100 illustrated in FIG. 11 and discussed in greater detail below. The example I/O unit 210 may be implemented using any type of data interface.

The example choice forecasting system 120 of FIG. 2 also includes a segment weight determination unit 215 to determine a set of segment weights corresponding to a respective set of population segments from an overall consumer population. As discussed above, each segment weight represents a weight of a respective population segment in an overall population. In the illustrated example, the segment weight determination unit 215 determines a set of segment weights for a particular overall consumer population by processing demographic information stored in the example input data storage unit 205 to divide the overall consumer population into demographic segments and to then assign a representative weight to each segment. For example, the segment weight determination unit 215 may divide the consumer population into segments based on one or more demographic criteria, such as age, sex, race, income, household size, etc. Then, the example segment weight determination unit 215 may weight each segment based on one or more factors associated with the segment's demographics, such as percentage of the consumer population included in the particular segment, the average or some other statistical measure of the purchasing power of the segment, etc. Additionally or alternatively, the segment weight determination unit 215 may determine some or all of the segment weights by treating each individual in a representative consumer populating as being a population segment, with each population segment having equal weight.

The example choice forecasting system 120 of FIG. 2 further includes a choice probability determination unit 220 to determine a set of choice probabilities corresponding to a respective set of population segments from an overall consumer population. As discussed above, each choice probability represents a probability that a respective population segment will choose a respective alternative from a set of possible alternatives (e.g., such as a set of possible product alternatives, a set of possible service alternatives, etc.). In the illustrated example, the choice probability determination unit 220 determines a set of choice probabilities corresponding to a respective set of population segments by initially using market research data stored in the example input storage unit 205 to determine various decision factors That could impact a consumer's decision to choose one alternative over another. For example, and as discussed above, the choice probability determination unit 220 could use any appropriate technique to determine a set of “utilities” with each utility representing a usefulness of a respective alternative as reported by or otherwise measured for a respective population segment. Other decision factors discussed above that could be determined by the example choice probability determination unit 220 include display sensitivities, price sensitivities, price reduction (e.g., coupon or price reduction tag) sensitivities, etc.

Then, the example choice probability determination unit 220 uses any appropriate technique to determine the set of choice probabilities from the various consumer decision factors determined from the market research data stored in the example input data storage unit 205. In the illustrated example, the choice probability determination unit 220 uses a multinomial logit model to determine the set of choice probabilities from a set of utilities representing the usefulness of each alternative to each population segment. For example, the choice probability determination unit 220 implements a multinomial logit model to determine a choice probability P(r,a) representing a probability of population segment r choosing alternative a using the expression of Equation 1, given by:

$$P ( r , a ) = \frac{{e}^{{U}_{r , a}}}{{\sum }_{b} {e}^{{U}_{r , b}}} ∀ r , a . \qquad Equation 1$$

In Equation 1, U_{r,a} represents the utility (e.g., usefulness) of alternative a to segment r. Accordingly, Equation 1 determines the choice probability of a particular population segment choosing a particular alternative as a function of the utility of the particular alternative to the particular population segment and the utility of all the alternatives to the particular population segment.

Additionally, the example choice forecasting system 120 of FIG. 2 includes a choice share determination unit 225 to determine choice shares for some or all of the alternatives in the set of possible alternatives. As discussed above, a particular choice share corresponding to a particular alternative represents a weighted average of choice probabilities for the particular alternative across the entire consumer population. Alternatively, a particular choice share may be viewed as a probability that an individual selected randomly from the entire consumer population will choose (e.g., select) the particular alternative from the set of alternatives. Alternatively, a particular choice share corresponding to a particular alternative may represent a probability that an individual selected randomly from an individual population segment or a group of population segments chooses (e.g., selects) the alternative from a set or only a subset of the set of possible alternatives.

In the illustrated example, the choice share determination unit 225 determines two types of choice shares. The first type of choice shares are model choice shares (also known as calculated choice shares) determinable (e.g., calculated) from the set of segment weights determined by the example segment weight determination unit 215 and the corresponding set of choice probabilities determined by the example choice probability determination unit 220. The second type of choice shares are target choice shares (also known as estimated choice shares) determinable (e.g., estimated) from market research data stored in the example input data storage 205. In the illustrated example, the target choice shares are used, at least in part, to calibrate the segment weights and choice probabilities used to determine the model choice shares, as discussed in greater detail below.

Examining the operation of the example choice share determination unit 225 in greater detail, the choice share determination unit 225 determines a particular model choice share for a particular alternative by combining the choice probabilities corresponding to all population segments in the overall population (or particular subset of the population) choosing the particular alternative, with each choice probability weighted by its corresponding segment weight. Mathematically, the example choice share determination unit 225 determines each particular model choice share Cₐ for a particular alternative a using the expression of Equation 2, given by:

$${C}_{a} = {\sum }_{r} {w}_{r} P ( r , a ) ∀ a . \qquad Equation 2$$

In Equation 2, wᵣ represents the segment weight for population segment r as determined by the example segment weight determination unit 215, P(r,a) representing a probability of population segment r choosing alternative a as determined by the example choice probability determination unit 220 (e.g., which may be calculated according to the expression of Equation 1) and the summation is over all population segments r included in the overall consumer population (or particular subset of the population).

The example choice share determination unit 225 further determines a particular target choice share for a particular alternative from market research data stored in the example input data storage unit 205. In the illustrated example, the choice share determination unit 225 uses consumer purchasing data (e.g., generated from diaries and/or automated scanning equipment, such as bar code scanners, RFID scanners, etc., employed by members of a market research panel) and/or point-of-sale data provided by retailers, wholesalers, etc., as well any other types of data indicative of consumer purchasing behavior, to estimate choice shares for existing product alternatives, service alternatives, etc. Additionally or alternatively, the choice share determination unit 225 may use the consumer purchasing data, point-of-sale data and/or any other available data to estimated projected choice shares for new product alternatives, new service alternatives, etc. In the mathematical expressions and corresponding discussion that follow, the target choice share for alternative a is represented by the symbol Cₐ^{T}.

As mentioned above, the target choice shares Cₐ^{T} may be used, at least in part, to calibrate the segment weights wᵣ and choice probabilities P(r,a) used to determine the model choice shares Cₐ. The example calibration procedures described herein operate to produce calibrated segment weights wᵣ* and calibrated choice probabilities P*(r,a) that, if processed by the example choice share determination unit 225 according to, for example, Equation 2, would yield calibrated model choice shares Cₐ* substantially equal to the corresponding target choice shares Cₐ^{T}. By calibrating the segment weights and choice probabilities to yield model choice shares substantially equal to the existing known (or estimated) target choice shares, it is more likely that example choice forecasting system 120 will yield accurate, consistent, reliable, etc., forecasts of future choice shares, at least in some operating scenarios.

Returning to FIG. 2, to perform calibration of the segment weights and choice probabilities, the example choice forecasting system 120 includes a choice forecasting calibration unit 230. In the illustrated example, the choice forecasting calibration unit 230 operates to determine a set of calibrated choice probabilities P*(r,a) and a set of calibrated segment weights wᵣ* from a set of segment weights wᵣ determined by the example segment weight determination unit 215, a corresponding set of choice probabilities P(r,a) determined by the example choice probability determination unit 220, and corresponding sets of uncalibrated (e.g., model) choice shares Cₐ and target choice shares Cₐ^{T} determined by the example choice share determination unit 225. In particular, the example choice forecasting calibration unit 230 determines the calibrated choice probabilities P*(r,a) and calibrated segment weights wᵣ* such that resulting calibrated choice shares Cₐ* calculated from the calibrated choice probabilities P*(r,a) and the calibrated segment weights wᵣ* according to the expression in Equation 2 would be equal to the target choice shares Cₐ^{T}, as indicated in the expression in Equation 3, given by:

$${C}_{a}^{*} = {C}_{a}^{T} = {\sum }_{r} {w}_{r}^{*} {P}^{*} ( r , a ) ∀ a . \qquad Equation 3$$

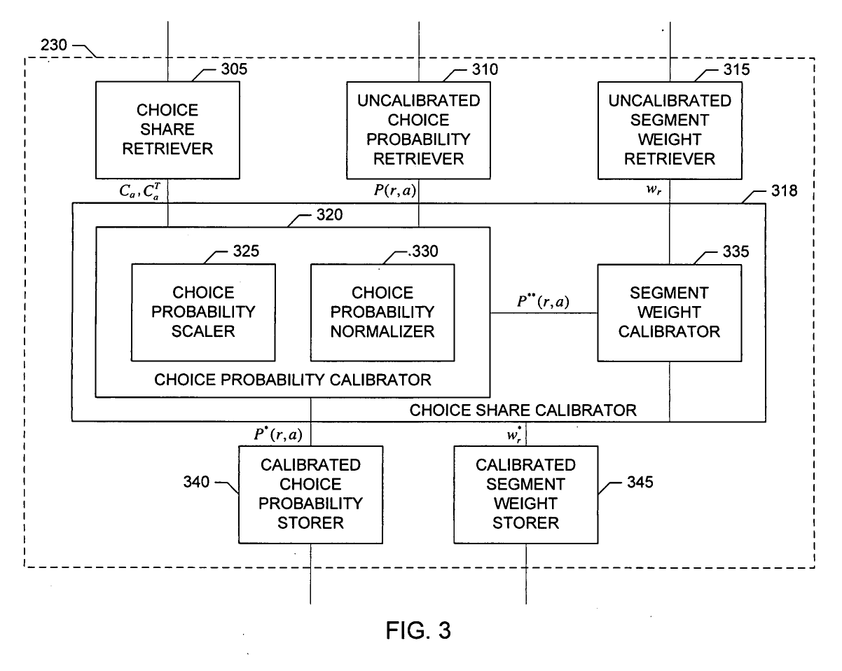

Furthermore, the example choice forecasting calibration unit 230 implements a calibration procedure that preserves certain relationships among the choice probabilities and segment weights before and after calibration. For example, the choice forecasting calibration unit 230 of FIG. 2 operates to preserve the relative contributions between each pair of population segments (e.g., r₁ and r₂) before and after calibration to each choice share corresponding to each possible alternative. Additionally, the example choice forecasting calibration unit 230 operates to ensure that population segments having high choice probabilities associated with alternatives having higher target (or calibrated) choice shares than uncalibrated choice shares and low choice probabilities associated with alternatives having lower target (or calibrated) choice shares than uncalibrated choice shares (e.g., “in sync” population segments) will see an increase in their calibrated segment weights relative to their uncalibrated segment weights. Conversely, the example choice forecasting calibration unit 230 operates to ensure that population segments having low choice probabilities associated with alternatives having higher target (or calibrated) choice shares than uncalibrated choice shares and high choice probabilities associated with alternatives having lower target (or calibrated) choice shares than uncalibrated choice shares (e.g., “out of sync” population segments) will see a decrease in their calibrated segment weights relative to their uncalibrated segment weights. How such properties are achieved by the example choice forecasting calibration unit 230 is discussed in greater detail below in connection with FIG. 3.

The example choice forecasting system 120 of FIG. 2 also includes a segment weight storage unit 235 and a choice probability storage unit 240 to store the calibrated segment weights wᵣ* and the calibrated choice probabilities P*(r,a), respectively, determined by the example choice forecasting calibration unit 230. Additionally, the example choice forecasting system 120 of FIG. 2 includes a choice share storage unit 245 to store the uncalibrated and calibrated (e.g., model) choice shares Cₐ and Cₐ*, as well as the target choice shares Cₐ^{T} determined by the example choice share determination unit 225. The example choice forecasting calibration unit 230 may also access the segment weights and choice probabilities stored, respectively, in the example segment weight storage unit 235 and the example choice probability storage unit 240 to allow these segments weights and choice probabilities to be recalibrated as necessary. Additionally or alternatively, the segment weights, the choice probabilities and/or the choice shares stored, respectively, in the example segment weight storage unit 235, the example choice probability storage unit 240 and the example choice share storage unit 245 may be output via the example I/O unit 210. The example segment weight storage unit 235, the example choice probability storage unit 240 and/or the example choice share storage unit 245 may be implemented by any type of storage unit, memory device, memory element, database, etc., such as the example mass storage device 1130 and/or the example volatile memory 1118 of the example computer system 1100 illustrated in FIG. 11 and discussed in greater detail below.

While an example manner of implementing the example choice forecasting system 120 of FIG. 1 has been illustrated in FIG. 2, one or more of the elements, processes and/or devices illustrated in FIG. 2 may be combined, divided, re-arranged, omitted, eliminated and/or implemented in any other way. Further, the example I/O unit 210, the example segment weight determination unit 215, the example choice probability weight determination unit 220, the example choice share determination unit 225, the example choice forecasting calibration unit 230 and/or, more generally, the example choice forecasting system 120 of FIG. 2 may be implemented by hardware, software, firmware and/or any combination of hardware, software and/or firmware. Thus, for example, any of the example I/O unit 210, the example segment weight determination unit 215, the example choice probability weight determination unit 220, the example choice share determination unit 225, the example choice forecasting calibration unit 230 and/or, more generally, the example choice forecasting system 120 could be implemented by one or more circuit(s), programmable processor(s), application specific integrated circuit(s) (ASIC(s)), programmable logic device(s) (PLD(s)) and/or field programmable logic device(s) (FPLD(s)), etc. When any of the appended claims are read to cover a purely software and/or firmware implementation, at least one of the example choice forecasting system 120, the example I/O unit 210, the example segment weight determination unit 215, the example choice probability weight determination unit 220, the example choice share determination unit 225 and/or the example choice forecasting calibration unit 230 are hereby expressly defined to include a tangible medium such as a memory, digital versatile disk (DVD), compact disk (CD), etc., storing such software and/or firmware. Further still, the example choice forecasting system 120 of FIG. 2 may include one or more elements, processes and/or devices in addition to, or instead of, those illustrated in FIG. 2, and/or may include more than one of any or all of the illustrated elements, processes and devices.

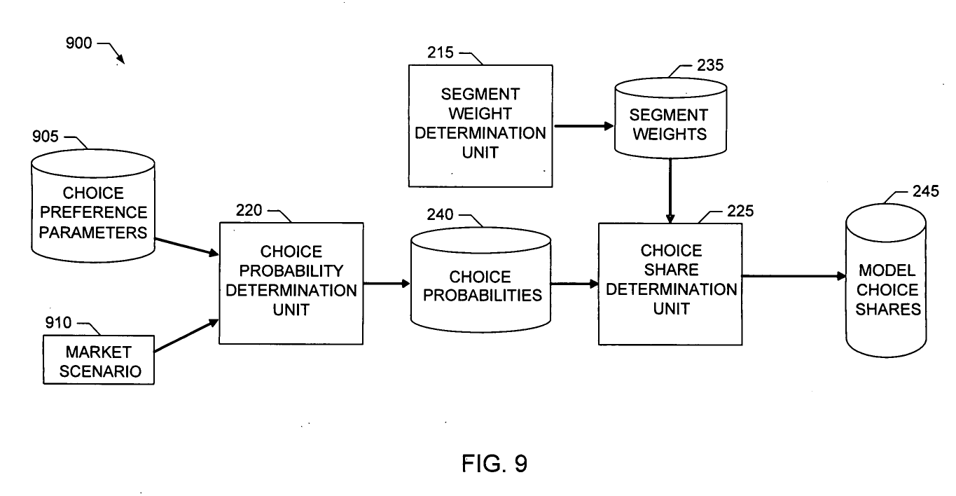

A block diagram of an example operation 900 of the example choice forecasting system 120 of FIG. 2 is illustrated in FIG. 9. With reference to the example choice forecasting system 120 of FIG. 2, the example operation 900 of FIG. 9 depicts the example choice probability determination unit 220 determining a set of choice probabilities. As described above, the example choice probability determination unit 220 calculates choice probabilities for each population segment from an overall population choosing each alternative from a set of possible alternatives. In the illustrated example, the choice probability determination unit 220 determines the set of choice probabilities using choice preference parameters 905 (e.g., such as a set of utilities determined from market research data as described above) and a specified market scenario 910 (e.g., a specified population, a specified set of possible alternatives, etc.). The choice preference parameters 905 and/or the market scenario 910 may be obtained by the example choice probability determination unit 220 from, for example, the input storage unit 205 (not shown in FIG. 9). The example choice probability determination unit 220 stores the determined set of choice probabilities in the example choice probability storage unit 240 as shown.

The example operation 900 of the example choice forecasting system 120 also depicts the example choice share determination unit 225 determining a set of model choice shares. As described above, the example choice share determination unit 225 calculates choice shares representing (1) a weighted average of choice probabilities for a particular alternative across the entire consumer population, and/or (2) a probability that an individual selected randomly from a consumer population will choose (e.g., select) a particular alternative from the set of alternatives. In the illustrated example, the choice share determination unit 225 determines the set of model choice shares from the set of choice probabilities stored in the example choice probability storage unit 240 and a set of segment weights stored in the example segment weight storage unit 235. As described above, the example segment weight determination unit 215 determines the set of segment weights from, for example, demographic information stored in the example input data storage unit 205 (not shown in FIG. 9). The example choice share determination unit 225 stores the determined set of model choice shares in the example choice share storage unit 245 as shown.

A block diagram of an example implementation of the choice forecasting calibration unit 230 of FIG. 2 is illustrated in FIG. 3. The example choice forecasting calibration unit 230 of FIG. 3 includes a choice share retriever 305 to retrieve uncalibrated (e.g., model) choice shares Cₐ and target choice shares Cₐ^{T}, for example, as determined by the example choice share determination unit 225 and/or as stored in the example choice share storage unit 245. The example choice forecasting calibration unit 230 of FIG. 3 also includes an uncalibrated choice probability retriever 310 to retrieve uncalibrated choice probabilities P(r,a) (or calibrated choice probabilities undergoing recalibration), for example, as determined by the example choice probability determination unit 220 and/or as stored in the example choice probability storage unit 240. The example choice forecasting calibration unit 230 of FIG. 3 further includes an uncalibrated segment weight retriever 315 to retrieve uncalibrated segment weights wᵣ (or calibrated segment weights undergoing recalibration), for example, as determined by the example segment weight determination unit 215 and/or as stored in the example segment weight storage unit 235.

The example choice forecasting calibration unit 230 of FIG. 3 also includes a choice share calibrator 318 to calibrate choice probabilities and segment weights to yield desired target choice shares, as discussed in greater detail below. To perform choice probability calibration, the example choice share calibrator 318 includes a choice probability calibrator 320. The example choice probability calibrator 320 is configured to use the uncalibrated (e.g., model) choice shares Cₐ and target choice shares Cₐ^{T} retrieved by the example choice share retriever 305 to calibrate the uncalibrated choice probabilities P(r,a) retrieved by the example uncalibrated choice probability retriever 310 to determine corresponding calibrated choice probabilities P*(r,a). In particular, the choice probability calibrator 320 includes a choice probability scaler 325 and a choice probability normalizer 330 to perform such calibration according to the following description.

In the illustrated example, the choice probability scaler 325 operates to scale each uncalibrated choice probability P(r,a) representing the probability of the particular population segment r choosing the particular alternative a to yield an intermediate scaled choice probability P**(r,a) corresponding to the population segment r choosing the particular alternative a. In an example implementation, the choice probability scaler 325 determines the intermediate scaled choice probability P**(r,a) by scaling the uncalibrated choice probability P(r,a) by the ratio of the target choice share Cₐ^{T} and the uncalibrated choice share Cₐ corresponding to the particular alternative a represented by the uncalibrated choice probability P(r,a). Mathematically, the example choice probability scaler 325 determines each intermediate scaled choice probability P**(r,a) corresponding to a particular population segment r choosing a particular alternative a using the expression of Equation 4, given by:

$${P}^{**} ( r , a ) = \frac{{C}_{a}^{T}}{{C}_{a}} P ( r , a ) ∀ r , a . \qquad Equation 4$$

In the illustrated example, the choice probability normalizer 330 operates to normalize each intermediate scaled choice probability P**(r,a) corresponding to a particular population segment r choosing a particular alternative a to yield the calibrated choice probability P*(r,a) corresponding to the population segment r choosing the particular alternative a. The example choice probability normalizer 330 normalizes the intermediate scaled choice probabilities P**(r,a) to yield the calibrated choice probabilities P*(r,a) to ensure that all of the calibrated choice probabilities P*(r,a) corresponding to a particular population segment r sum to a value of one (1). In an example implementation, the example choice probability normalizer 330 normalizes the intermediate scaled choice probability P**(r,a) by a sum of all intermediate scaled choice probability P**(r,b), each corresponding to the particular population segment r choosing one of the alternatives b in the set of alternatives. Mathematically, the example choice probability normalizer 330 determines each calibrated choice probability P*(r,a) representing a calibrated probability of a particular population segment r choosing a particular alternative a using the expression of Equation 5, given by:

$${P}^{*} ( r , a ) = \frac{{P}^{**} ( r , a )}{{\sum }_{b} {P}^{**} ( r , b )} ∀ r , a . \qquad Equation 5$$

Having all of the calibrated choice probabilities P*(r,a) corresponding to a particular population segment r sum to one (1) corresponds to an example operating scenario constraint in which each population segment r is ultimately allowed to choose only one alternative a from the set of possible alternatives. However, in other example operating scenarios, the example choice probability normalizer 330 may be configured to yield calibrated choice probabilities P*(r,a) that sum to a value greater than one (1) for a particular population segment r if population segments are allowed to ultimately choose more than one alternative from the set of alternatives. Additionally or alternatively, the example choice probability normalizer 330 may be configured to yield calibrated choice probabilities P*(r,a) that sum to a value less than one (1) for a particular population segment r if population segments are allowed to ultimately choose no alternatives from the set of alternatives.

To perform segment weight calibration, the example choice share calibrator 318 further includes a segment weight calibrator 335. The example segment weight calibrator 335 is configured to use the intermediate scaled choice probabilities P**(r,a) determined by the example choice probability scaler 325 to calibrate the uncalibrated segment weights wᵣ retrieved by the example uncalibrated segment weight retriever 315 to determine corresponding calibrated segment weights wᵣ*. In particular, the example segment weight calibrator 335 is configured to scale each uncalibrated segment weight wᵣ corresponding to a particular population segment r by a sum of all intermediate scaled choice probability P**(r,b), each corresponding to the particular population segment r choosing one of the alternatives b in the set of alternatives. Mathematically, the example segment weight calibrator 335 determines each calibrated segment weight wᵣ* representing a weight of a particular population segment r using the expression of Equation 6, given by:

$${w}_{r}^{*} = {w}_{r} {\sum }_{b} {P}^{**} ( r , b ) ∀ r . \qquad Equation 6$$

In an alternative example implementation of the choice forecasting calibration unit 230 of FIG. 3, the multinomial logit model of Equation 1 is used to determine the uncalibrated choice probabilities P(r,a) from a set of uncalibrated utilities U_{r,a} representing the utility (e.g., usefulness) of alternative a to segment r. In such an example implementation, the choice probability calibrator 320 can be configured to determine the calibrated choice probabilities P*(r,a) by calibrating the uncalibrated utilities U_{r,a} to determine corresponding calibrated utilities U_{r,a}*. For example, the choice probability calibrator 320 can be configured to offset each uncalibrated utility U_{r,a} corresponding to a particular alternative a by a calibration factor τₐ that is constant for all segments r as represented in the expression of Equation 7, given by:

U_{r,a}*=U_{r,a}+τₐ ∀r,a. Equation 7

Additionally, the calibration factor τₐ in this example can be determined based on a ratio of the target choice share Cₐ^{T} and the uncalibrated choice share Cₐ corresponding to the particular alternative a as represented in the expression of Equation 8, given by:

$${τ}_{a} = ln ( \frac{{C}_{a}^{T}}{{C}_{a}} ) ∀ a . \qquad Equation 8$$

In this example, the calibrated choice probabilities P*(r,a) can then be determined directly from the calibrated utilities U_{r,a}* according to the expression of Equation 9, given by:

$${P}^{*} ( r , a ) = \frac{{e}^{{U}_{r , a}^{*}}}{{\sum }_{b} {e}^{{U}_{r , b}^{*}}} ∀ r , a . \qquad Equation 9$$

In such an alternative implementation based on the multinomial logit model, operation of the example segment weight calibrator 335 remains unchanged and, thus, still uses the intermediate scaled choice probabilities P**(r,a) to determine the calibrated segment weights wᵣ* according to Equation 6.

To store the calibrated choice probabilities P*(r,a) and the calibrated segment weights wᵣ*, the example choice forecasting calibration unit 230 of FIG. 3 includes a calibrated choice probability storer 340 and a calibrated segment weight storer 345. In the illustrated example, the calibrated choice probability storer 340 is configured to process the calibrated choice probabilities P*(r,a) determined by the example choice probability calibrator 320 for storage in, for example, the example choice probability storage unit 240 of FIG. 2. Similarly, the example calibrated segment weight storer 345 is configured to process the calibrated segment weights wᵣ* determined by the example segment weight calibrator 335 for storage in, for example, the example segment weight storage unit 235 of FIG. 2.

As discussed above, the example choice forecasting calibration unit 230 operates to preserve certain relationships among the choice probabilities and segment weights before and after calibration. In the illustrated example of FIG. 3, the choice forecasting calibration unit 230 is configured to preserve the relative contributions between each pair of population segments (e.g., r₁ and r₂) before and after calibration to each choice share corresponding to each possible alternative. This property of the example choice forecasting calibration unit 230 of FIG. 3 is readily seen by combining the expressions in Equation 4, Equation 5 and Equation 6 to reveal the relationship of Equation 10, given by:

$$\frac{{C}_{a}^{T}}{{C}_{a}} = \frac{{w}_{{r}_{1}}^{*} {P}^{*} ( {r}_{1} , a )}{{w}_{{r}_{1}} P ( {r}_{1} , a )} = \frac{{w}_{{r}_{2}}^{*} {P}^{*} ( {r}_{2} , a )}{{w}_{{r}_{2}} P ( {r}_{2} , a )} ∀ {r}_{1} , {r}_{2} , a . \qquad Equation 10$$

Rearranging the expression in Equation 10 yields the expression of Equation 11, given by:

$$\frac{{w}_{{r}_{1}}^{*} {P}^{*} ( {r}_{1} , a )}{{w}_{{r}_{2}}^{*} {P}^{*} ( {r}_{2} , a )} = \frac{{w}_{{r}_{1}} P ( {r}_{1} , a )}{{w}_{{r}_{2}} P ( {r}_{2} , a )} ∀ {r}_{1} , {r}_{2} , a \qquad Equation 11$$

The expression of Equation 11 illustrates that the relative contribution wᵣ_{₁}P(r₁, a)/wᵣ_{₂}P(r₂, a) of each pair of population segments r₁ and r₂ to the uncalibrated choice share Cₐ before calibration is equal to the relative contribution wᵣ_{₁}*P*(r₁,a)/wᵣ_{₂}*P*(r₂,a) of this same pair of population segments r₁ and r₂ to the calibrated choice share Cₐ*=Cₐ^{T} after calibration.

Additionally, as discussed above, the example choice forecasting calibration unit 230 operates to ensure that population segments having high choice probabilities associated with alternatives having higher target (or calibrated) choice shares than uncalibrated choice shares and low choice probabilities associated with alternatives having lower target (or calibrated) choice shares than uncalibrated choice shares (e.g., “in sync” population segments) will see an increase in their calibrated segment weights relative to their uncalibrated segment weights. Conversely, the example choice forecasting calibration unit 230 operates to ensure that population segments having low choice probabilities associated with alternatives having higher target (or calibrated) choice shares than uncalibrated choice shares and high choice probabilities associated with alternatives having lower target (or calibrated) choice shares than uncalibrated choice shares (e.g., “out of sync” population segments) will see a decrease in their calibrated segment weights relative to their uncalibrated segment weights.

These properties of the example choice forecasting calibration unit 230 of FIG. 3 are readily seen by combining the expressions in Equation 4 and Equation 6 to reveal the relationship of Equation 12, given by

$$\frac{{w}_{r}^{*}}{{w}_{r}} = {\sum }_{a} ( \frac{{C}_{a}^{T}}{{C}_{a}} ) P ( r , a ) ∀ r . \qquad Equation 12$$

The expression of Equation 12 illustrates that the ratio of a calibrated segment weight to a corresponding uncalibrated segment weight, wᵣ*/wᵣ, will increase if the particular segment r has high choice probabilities P(r,a) associated with alternatives a having choice shares which increase after calibration (i.e., (Cₐ^{T}/Cₐ)>1 ) and low choice probabilities P(r,a) associated with alternatives a having choice shares which decrease after calibration (i.e., (Cₐ^{T}/Cₐ)<1). Conversely, the expression of Equation 12 illustrates that the ratio of a calibrated segment weight to a corresponding uncalibrated segment weight, wᵣ*/wᵣ, will decrease if the particular segment r has low choice probabilities P(r,a) associated with alternatives a having choice shares which increase after calibration (i.e., (Cₐ^{T}/Cₐ)>1) and high choice probabilities P(r,a) associated with alternatives a having choice shares which decrease after calibration (i.e., (Cₐ^{T}/Cₐ)<1).

While an example manner of implementing the example choice forecasting calibration unit 230 of FIG. 2 has been illustrated in FIG. 3, one or more of the elements, processes and/or devices illustrated in FIG. 3 may be combined, divided, re-arranged, omitted, eliminated and/or implemented in any other way. Further, the example choice share retriever 305, the example uncalibrated choice probability retriever 310, the example uncalibrated segment weight retriever 315, the example choice share calibrator 318, the example choice probability calibrator 320, the example choice probability scaler 325, the example choice probability normalizer 330, the example segment weight calibrator 335, the example calibrated choice probability storer 340, the example calibrated segment weight storer 345 and/or, more generally, the example choice forecasting calibration unit 230 of FIG. 3 may be implemented by hardware, software, firmware and/or any combination of hardware, software and/or firmware. Thus, for example, any of the example choice share retriever 305, the example uncalibrated choice probability retriever 310, the example uncalibrated segment weight retriever 315, the example choice share calibrator 318, the example choice probability calibrator 320, the example choice probability scaler 325, the example choice probability normalizer 330, the example segment weight calibrator 335, the example calibrated choice probability storer 340, the example calibrated segment weight storer 345 and/or, more generally, the example choice forecasting calibration unit 230 could be implemented by one or more circuit(s), programmable processor(s), application specific integrated circuit(s) (ASIC(s)), programmable logic device(s) (PLD(s)) and/or field programmable logic device(s) (FPLD(s)), etc. When any of the appended claims are read to cover a purely software and/or firmware implementation, at least one of the example choice forecasting calibration unit 230, the example choice share retriever 305, the example uncalibrated choice probability retriever 310, the example uncalibrated segment weight retriever 315, the example choice share calibrator 318, the example choice probability calibrator 320, the example choice probability scaler 325, the example choice probability normalizer 330, the example segment weight calibrator 335, the example calibrated choice probability storer 340 and/or the example calibrated segment weight storer 345 are hereby expressly defined to include a tangible medium such as a memory, digital versatile disk (DVD), compact disk (CD), etc., storing such software and/or firmware. Further still, the example choice forecasting calibration unit 230 of FIG. 3 may include one or more elements, processes and/or devices in addition to, or instead of, those illustrated in FIG. 3, and/or may include more than one of any or all of the illustrated elements, processes and devices.

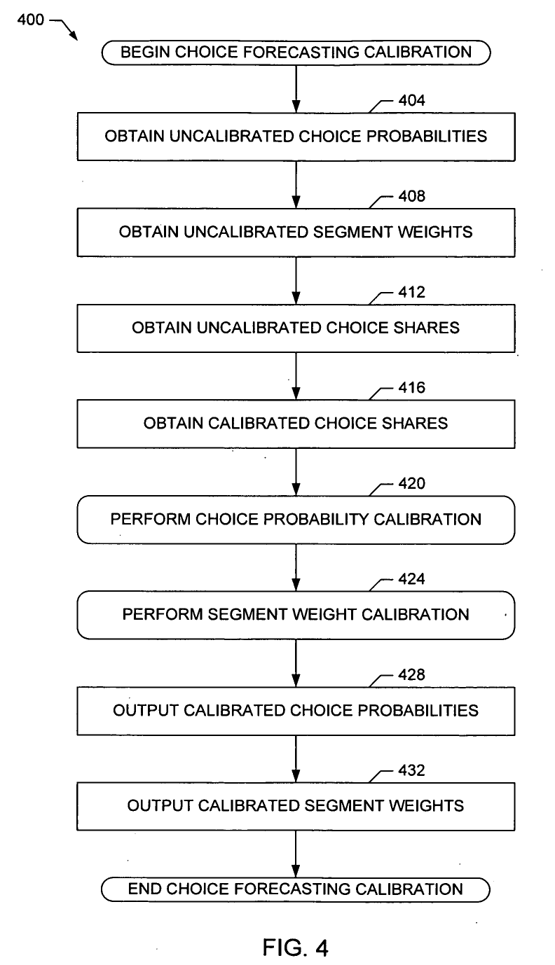

Flowcharts representative of example machine readable instructions that may be executed to implement, at least in part, the example choice forecasting calibration unit 230, the example choice share retriever 305, the example uncalibrated choice probability retriever 310, the example uncalibrated segment weight retriever 315, the example choice share calibrator 318, the example choice probability calibrator 320, the example choice probability scaler 325, the example choice probability normalizer 330, the example segment weight calibrator 335, the example calibrated choice probability storer 340 and/or the example calibrated segment weight storer 345 are shown in FIGS. 4-8 and 10. In these examples, the machine readable instructions represented by each flowchart may comprise one or more programs for execution by: (a) a processor, such as the processor 1112 shown in the example computer 1100 discussed below in connection with FIG. 11, (b) a controller, and/or (c) any other suitable device. The one or more programs may be embodied in software stored on a tangible medium such as, for example, a flash memory, a CD-ROM, a floppy disk, a hard drive, a DVD, or a memory associated with the processor 1112, but the entire program or programs and/or portions thereof could alternatively be executed by a device other than the processor 1112 and/or embodied in firmware or dedicated hardware (e.g., implemented by an application specific integrated circuit (ASIC), a programmable logic device (PLD), a field programmable logic device (FPLD), discrete logic, etc.). For example, any or all of the example choice forecasting calibration unit 230, the example choice share retriever 305, the example uncalibrated choice probability retriever 310, the example uncalibrated segment weight retriever 315, the example choice share calibrator 318, the example choice probability calibrator 320, the example choice probability scaler 325, the example choice probability normalizer 330, the example segment weight calibrator 335, the example calibrated choice probability storer 340 and/or the example calibrated segment weight storer 345 could be implemented by any combination of software, hardware, and/or firmware. Also, some or all of the machine readable instructions represented by the flowchart of FIGS. 4-8 and 10 may be implemented manually. Further, although the example machine readable instructions are described with reference to the flowcharts illustrated in FIGS. 4-8 and 10, many other techniques for implementing the example methods and apparatus described herein may alternatively be used. For example, with reference to the flowcharts illustrated in FIGS. 4-8 and 10, the order of execution of the blocks may be changed, and/or some of the blocks described may be changed, eliminated, combined and/or subdivided into multiple blocks.

Example machine readable instructions 400 to perform choice forecasting calibration that may be executed to implement the example choice forecasting calibration unit 230 of FIG. 3 are represented by the flowchart shown in FIG. 4. With reference to the example choice forecasting calibration unit 230 illustrated in FIG. 3, the example machine readable instructions 400 of FIG. 4 begin execution at block 404 at which the example uncalibrated choice probability retriever 310 included in the example choice forecasting calibration unit 230 retrieves a set of uncalibrated choice probabilities P(r,a) (and/or a set of calibrated choice probabilities undergoing recalibration). The set of uncalibrated choice probabilities P(r,a) may be retrieved, for example, from the example choice probability determination unit 220 and/or the example choice probability storage unit 240.

Control next proceeds to block 408 at which the example uncalibrated segment weight retriever 315 included in the example choice forecasting calibration unit 230 retrieves a set of uncalibrated segment weights wᵣ (and/or a set of calibrated segment weights undergoing recalibration). The set of uncalibrated segment weights wᵣ may be retrieved for example, from the example segment weight determination unit 215 and/or the example segment weight storage unit 235. Next, at blocks 412 and 416 the example choice share retriever 305 included in the example choice forecasting calibration unit 230 retrieves a set of uncalibrated (e.g., model) choice shares Cₐ and a corresponding set of target choice shares Cₐ^{T}. The set of uncalibrated choice shares Cₐ and the set of target choice shares Cₐ^{T} may be retrieved, for example, from the example choice share determination unit 225 and/or the example choice share storage unit 245.

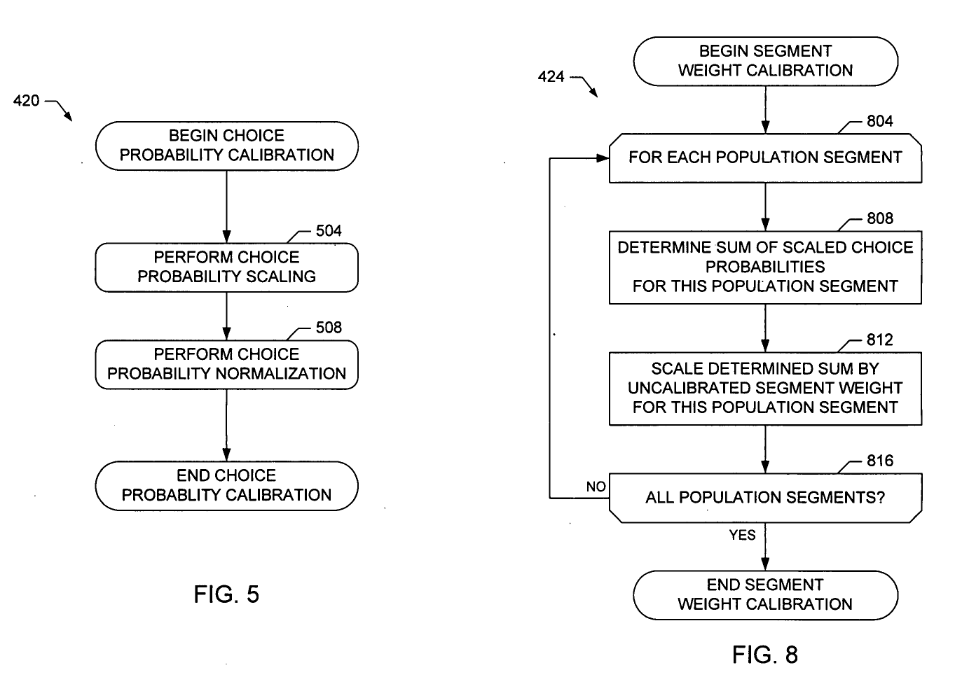

After the uncalibrated choice probabilities P(r,a), the uncalibrated segment weights wᵣ, the uncalibrated choice shares Cₐ and target choice shares Cₐ^{T} have been retrieved, control proceeds to block 420. At block 420, the example choice probability calibrator 320 included in the example choice forecasting calibration unit 230 performs a choice probability calibration procedure to calibrate the set of uncalibrated choice probabilities P(r,a) to determine a corresponding set of calibrated choice probabilities P*(r,a). Example machine readable instructions that may be used to implement an example choice probability calibration procedure at block 420 are illustrated in FIG. 5 and discussed in greater detail below.

Next, control proceeds to block 424 at which the example segment weight calibrator 335 included in the example choice forecasting calibration unit 230 performs a segment weight calibration procedure to calibrate the set of uncalibrated segment weights wᵣ to determine a corresponding set of calibrated segment weights wᵣ*. Example machine readable instructions that may be used to implement an example segment weight calibration procedure at block 424 are illustrated in FIG. 8 and discussed in greater detail below.

After the calibrated choice probabilities P*(r,a) and the calibrated segment weights wᵣ* are determined, control proceeds to blocks 428 and 432. At block 428, the example calibrated choice probability storer 340 included in the example choice forecasting calibration unit 230 outputs the calibrated choice probabilities P*(r,a), for example, for storage in the example choice probability storage unit 240. Similarly, at block 432, the example calibrated segment weight storer 345 included in the example choice forecasting calibration unit 230 outputs the calibrated segment weights wᵣ*, for example, for storage in the example segment weight storage unit 235. As discussed above, the calibrated segment weights wᵣ* and calibrated choice probabilities P*(r,a) are determined such that they would yield calibrated model choice shares Cₐ* substantially equal to the corresponding target choice shares Cₐ^{T}. Furthermore, as noted above, by calibrating the segment weights and choice probabilities to yield model choice shares substantially equal to the existing known (or estimated) target choice shares, it is more likely that forecasts of future choice shares will be more accurate, consistent, reliable, etc., at least in some operating scenarios. After processing at blocks 428 and 432 completes, execution of the example machine readable instructions 400 then ends.

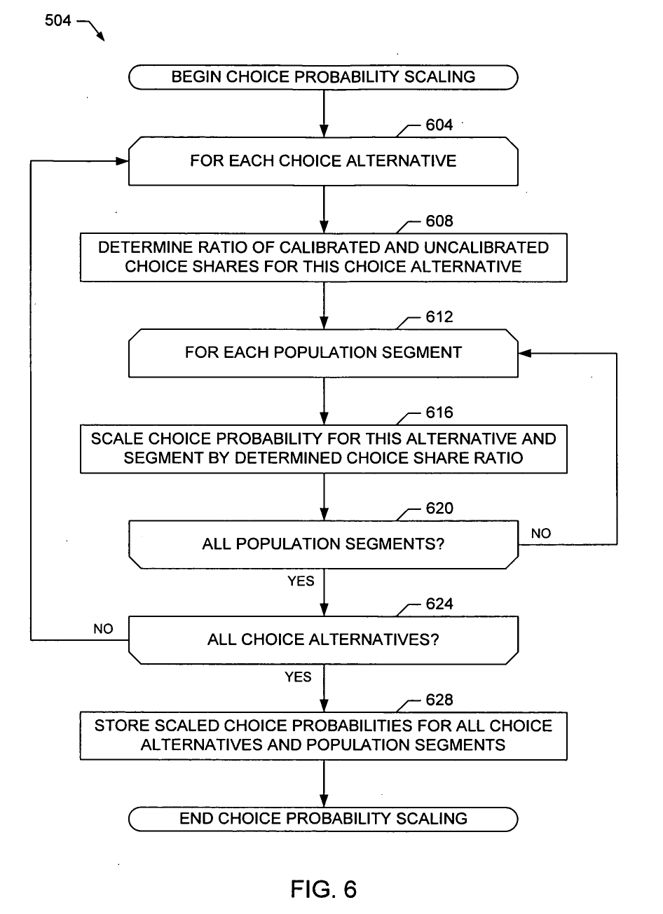

Example machine readable instructions 420 to perform choice probability calibration that may be executed to implement the example choice probability calibrator 320 included in the example choice probability calibration unit 230 of FIG. 3 and/or an example choice probability calibration procedure at block 420 of FIG. 4 are represented by the flowchart shown in FIG. 5. With reference to FIG. 3, the example machine readable instructions 420 of FIG. 5 begin execution at block 504 at which the example choice probability calibrator 320 performs a choice probability scaling procedure to scale each uncalibrated choice probability P(r,a) undergoing calibration. For example, at block 420 the example choice probability scaler 325 included in the example choice probability calibrator 320 scales each uncalibrated choice probability P(r,a) representing the probability of a particular population segment r choosing a particular alternative a to yield an intermediate scaled choice probability P**(r,a) corresponding to the population segment r choosing the particular alternative a. Example machine readable instructions that may be used to implement an example choice probability scaling procedure at block 504 are illustrated in FIG. 6 and discussed in greater detail below.

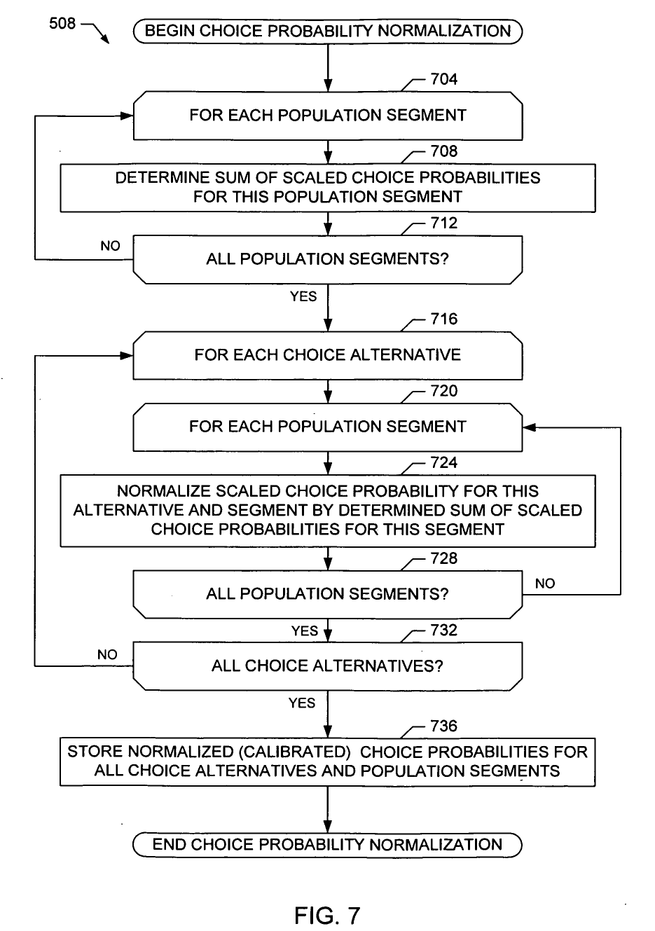

Next, control proceeds to block 508 at which the example choice probability calibrator 320 performs a choice probability normalization procedure to normalize each intermediate scaled choice probability P**(r,a) determined at block 504. For example, at block 508 the example choice probability normalizer 330 included in the example choice probability calibrator 320 normalizes each intermediate scaled choice probability P**(r,a) corresponding to a particular population segment r choosing a particular alternative a to yield the corresponding calibrated choice probability P*(r,a). Example machine readable instructions that may be used to implement an example choice probability normalization procedure at block 508 are illustrated in FIG. 7 and discussed in greater detail below. After processing at block 508 completes, execution of the example machine readable instructions 420 of FIG. 5 ends.

Example machine readable instructions 504 to perform choice probability scaling that may be executed to implement the example choice probability scaler 325 included in the example choice probability calibrator 320 of the example choice probability calibration unit 230 of FIG. 3 and/or an example choice probability scaling procedure at block 504 of FIG. 5 are represented by the flowchart shown in FIG. 6. In particular, the example machine readable instructions 504 implement the expression of Equation 4 described above. With reference to FIG. 3, the example machine readable instructions 504 of FIG. 6 begin execution at block 604 at which the example choice probability scaler 325 begins iterating through each alternative a in a set of possible alternatives. For each iteration through the set of alternatives a, control proceeds to block 608 at which the example choice probability scaler 325 determines the ratio Cₐ^{T}/Cₐ of the target choice share Cₐ^{T} to the uncalibrated choice share Cₐ for the current alternative iteration a.

Next, control proceeds to block 612 at which the example choice probability scaler 325 begins iterating through each population segment r of an overall consumer population. For each iteration through the population segments r, control proceeds to block 616 at which the example choice probability scaler 325 scales the uncalibrated choice probability P(r,a) corresponding to the current population segment iteration r and the current alternative iteration a by the choice share ratio Cₐ^{T}/Cₐ determined at block 608 for the current alternative iteration a. Such scaling yields the intermediate scaled choice probability P**(r,a) of Equation 4 for the current population segment iteration r and the current alternative iteration a.

Next, control proceeds to block 620 at which the example choice probability scaler 325 determines whether iteration through the population segments r of the overall consumer population is complete. If iteration through the population segments r is not complete (block 620), control returns to block 612 at which the example choice probability scaler 325 begins processing the next iteration through the population segments r. If, however, iteration through the population segments r is complete (block 620), control proceeds to block 624 at which the example choice probability scaler 325 determines whether iteration through the set of alternatives a is complete. If iteration through the set of alternatives a is not complete (block 624), control returns to block 608 at which the example choice probability scaler 325 begins processing the next iteration through the set of alternatives a. However, if iteration through the set of alternatives a is complete (block 624), control proceeds to block 628.

At block 628, the example choice probability scaler 325 stores the set of the intermediate scaled choice probabilities P**(r,a) determined by iterating through blocks 608 and 616. For example, the choice probability scaler 325 may store the set of the intermediate scaled choice probabilities P**(r,a) temporarily for subsequent calibration processing, for example, in temporary storage (not shown in FIG. 3), in the example choice probability storage unit 240, in the example input data storage unit 205, etc. After processing at block 628 completes, execution of the example machine readable instructions 504 of FIG. 6 ends.

Example machine readable instructions 508 to perform choice probability normalization that may be executed to implement the example choice probability normalizer 330 included in the example choice probability calibrator 320 of the example choice probability calibration unit 230 of FIG. 3 and/or an example choice probability normalization procedure at block 508 of FIG. 5 are represented by the flowchart shown in FIG. 7. In particular, the example machine readable instructions 508 implement the expression of Equation 5 described above. With reference to FIG. 3, the example machine readable instructions 508 of FIG. 7 begin execution at block 704 at which the example choice probability normalizer 330 begins iterating through each population segment r of an overall consumer population. For each iteration through the set of population segments r, control proceeds to block 708 at which the example choice probability normalizer 330 determines the sum over the set of all alternatives b of all intermediate scaled choice probabilities P**(r,b) corresponding to the current population segment iteration r. In other words, for each iteration through block 708, the example choice probability normalizer 330 evaluates the expression

$${\sum }_{b} {P}^{**} ( r , b )$$

corresponding to the current population segment iteration r.

Next, control proceeds to block 712 at which the example choice probability normalizer 330 determines whether iteration through the population segments r of the overall consumer population is complete. If iteration through the population segments r is not complete (block 712), control returns to block 704 at which the example choice probability normalizer 330 begins processing the next iteration through the population segments r. If, however, iteration through the population segments r is complete (block 712), control proceeds to block 716 at which the example choice probability normalizer 330 begins iterating through each alternative a in a set of possible alternatives. Control next proceeds to block 720 at which the example choice probability normalizer 330 begins iterating through each population segment r of the overall consumer population.

Then, for each iteration through the set of alternatives a and the set of population segments r, control proceeds to block 724 at which the example choice probability normalizer 330 normalizes the intermediate scaled choice probabilities P**(r,a) corresponding to the current population segment iteration r and the current alternative iteration a by the sum over the set of all alternatives b of all intermediate scaled choice probabilities P**(r,b) corresponding to the current population segment iteration r. Such normalization yields the calibrated choice probability P*(r,a) of Equation 5 for the current population segment iteration r and the current alternative iteration a.

Next, control proceeds to block 728 at which the example choice probability normalizer 330 determines whether iteration through the population segments r of the overall consumer population is complete. If iteration through the population segments r is not complete (block 728), control returns to block 720 at which the example choice probability normalizer 330 begins processing the next iteration through the population segments r. If, however, iteration through the population segments r is complete (block 728), control proceeds to block 732 at which the example choice probability normalizer 330 determines whether iteration through the set of alternatives a is complete. If iteration through the set of alternatives a is not complete (block 732), control returns to block 716 at which the example choice probability normalizer 330 begins processing the next iteration through the set of alternatives a. However, if iteration through the set of alternatives a is complete (block 732), control proceeds to block 736.

At block 736, the example choice probability scaler 325 stores the set of the calibrated choice probabilities P*(r,a) determined by iterating through blocks 708 and 724. For example, the choice probability normalizer 330 may store the set of the calibrated choice probabilities P*(r,a) in the example choice probability storage unit 240 of FIG. 2. After processing at block 736 completes, execution of the example machine readable instructions 508 of FIG. 7 ends.

Example machine readable instructions 424 to perform segment weight calibration that may be executed to implement the example segment weight calibrator 335 included in the example choice probability calibration unit 230 of FIG. 3 and/or an example segment weight calibration procedure at block 424 of FIG. 4 are represented by the flowchart shown in FIG. 8. In particular, the example machine readable instructions 508 implement the expression of Equation 6 described above. With reference to FIG. 3, the example machine readable instructions 424 of FIG. 8 begin execution at block 804 at which the example segment weight calibrator 335 begins iterating through each population segment r of the overall consumer population.

Then, for each iteration through the set of population segments r, control proceeds to block 808 at which the example segment weight calibrator 335 determines the sum over the set of all alternatives b of all intermediate scaled choice probabilities P**(r,b) corresponding to the current population segment iteration r. In other words, for each iteration through block 808, the example segment weight calibrator 335 evaluates the expression

$${\sum }_{b} {P}^{**} ( r , b )$$

corresponding to the current population segment iteration r.

Next, control proceeds to block 812 at which the example segment weight calibrator 335 scales the uncalibrated segment weight wᵣ corresponding to the current population segment iteration r by the sum over the set of all alternatives b of all intermediate scaled choice probabilities P**(r,b) corresponding to the current population segment iteration r as determined at block 808. Such scaling yields the calibrated segment weight wᵣ* of Equation 6 for the current population segment iteration r.

Next, control proceeds to block 816 at which the example segment weight calibrator 335 determines whether iteration through the population segments r of the overall consumer population is complete. If iteration through the population segments r is not complete (block 816), control returns to block 804 at which the example segment weight calibrator 335 begins processing the next iteration through the population segments r. If, however, iteration through the population segments r is complete (block 816), execution of the example machine readable instructions 424 of FIG. 8 ends.

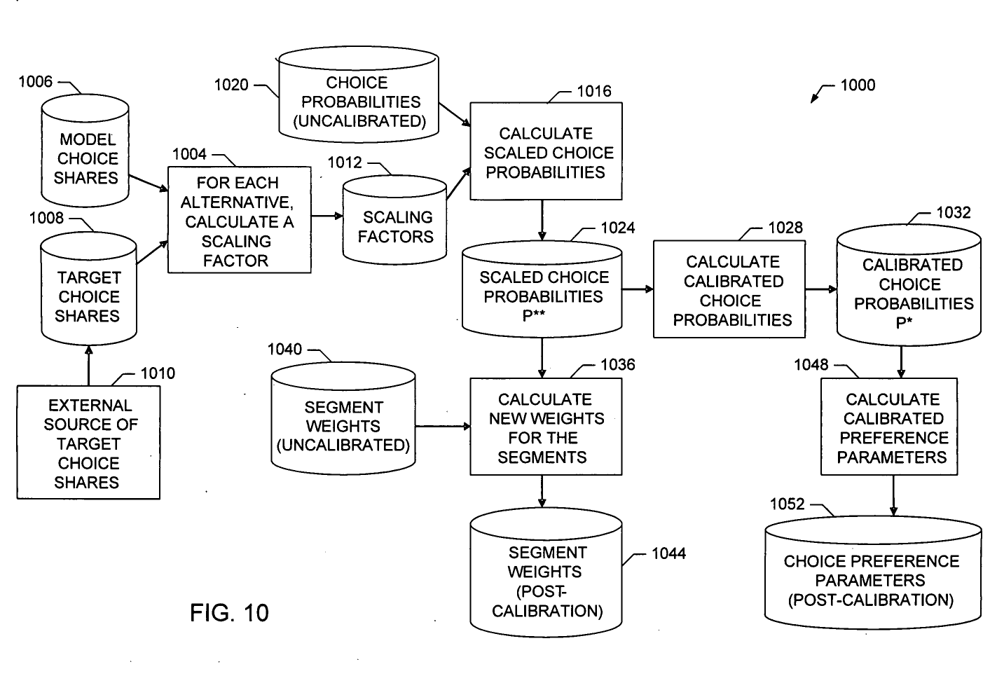

A block diagram representative of example machine readable instructions to perform an integrated choice forecasting calibration procedure 1000 that may be executed to implement the example choice forecasting calibration unit 230 of FIG. 3 is illustrated in FIG. 10. Although the two examples yield equivalent calibration results, the example calibration procedure of FIG. 10 differs from the example of FIGS. 4-8 primarily in that the example of FIG. 10 integrates choice probability calibration and segment weight calibration into a single calibration procedure. As such, the example calibration procedure of FIG. 10 may eliminate redundant operations, if present associated with the example of FIGS. 4-8, at least in some circumstances.

With reference to the example choice forecasting calibration unit 230 illustrated in FIG. 3, the example calibration procedure 1000 begins operation at block 1004 at which the example choice share calibrator 318 included in the example choice forecasting calibration unit 230 determines a scaling factor for each alternative a in a set of possible alternatives. In particular, at block 1000 the example choice share calibrator 318 determines the scaling factors as ratios Cₐ^{T}/Cₐ of the target choice shares Cₐ^{T} to the model (e.g., uncalibrated) choice shares Cₐ for the each alternative a. In the illustrated example, the model choice shares and the target choice shares are obtained from respective model and target choice share storage units(s) 1006 and 1008, which may be implemented collectively by the example choice share storage unit 245. Furthermore, the choice share calibrator 318 of the illustrated example stores the determined scaling factors in a scaling factor storage unit 1012. Also, in the example calibration procedure 1000 of FIG. 10, the target choice shares stored in the example target choice share storage unit 1008 are obtained at block 1010 from an external target choice share source. For example, and as described above, the target choice shares may be determined (e.g., estimated) at block 1010 from market research data obtained from one or more market research data sources 125 and stored in the example input data storage 205.

Next, at block 1016 the example choice share calibrator 318 scales a set of uncalibrated choice probabilities P(r,a) by the determined scaling factors stored in the example scaling factor storage unit 1012 to determine a corresponding set of intermediate scaled choice probabilities P**(r,a). In the illustrated example, the uncalibrated choice probabilities P(r,a) are obtained from an uncalibrated choice probability storage unit 1020, which may be implemented by the example choice probability storage unit 240. In the illustrated example, the choice share calibrator 318 stores the determined intermediate scaled choice probabilities P**(i, a) in a scaled choice probability storage unit 1024.

Next, at block 1028 the example choice share calibrator 318 determines a set of calibrated choice probabilities P*(r,a) from the set of intermediate scaled choice probabilities P**(r,a) and the set of uncalibrated choice probabilities P(r,a). For example, at block 1028 the example choice share calibrator 318 normalizes the uncalibrated choice probabilities P(r,a) using the intermediate scaled choice probabilities P**(r,a) to determine the calibrated choice probabilities P*(r,a), as described in greater detail above. In the illustrated example, the choice share calibrator 318 stores the determined calibrated choice probabilities P*(r,a) in a calibrated choice probability storage unit 1032, which may be implemented by the example choice probability storage unit 240.

At substantially the same time (e.g., in an integrated manner), at block 1036 the example choice share calibrator 318 determines a set of calibrated segment weights wᵣ* for each population segment iteration r. For example, at block 1036 the example choice share calibrator 318 scales the uncalibrated segment weights wᵣ using the intermediate scaled choice probabilities P**(r,a) to determine calibrated segment weights wᵣ*, as described in greater detail above. In the illustrated example, the uncalibrated segment weights wᵣ are obtained from an uncalibrated segment weight storage units 1040, which may be implemented by the example segment weight storage unit 235. In the illustrated example, the choice share calibrator 318 stores the determined calibrated segment weights wᵣ in a calibrated segment weight storage unit 1044, which may be implemented by the example segment weight storage unit 235.

Finally, at block 1048 the example choice share calibrator 318 determines a set of calibrated preference parameters. For example, at block 1048 the example choice share calibrator 318 may determine a set of calibrated utilities U_{r,a}* from a corresponding set of uncalibrated utilities U_{r,a} representing the utility (e.g., usefulness) of each alternative a to each population segment r. As described above, in at least some example implementation the uncalibrated choice probabilities P(r,a) are determined from the uncalibrated utilities U_{r,a} using a multinomial logit model. Accordingly, in an example implementation, a new set of calibrated utilities U_{r,a}* are determined at block 1048 to correspond to the calibrated choice probabilities P*(r,a) stored in a calibrated choice probability storage unit 1032. In the illustrated example, the choice share calibrator 318 stores the determined calibrated choice preference parameters (e.g., the determined calibrated utilities (U_{r,a}*) in a choice preference parameter storage unit 1052.

As described above in connection with FIG. 3, the particular scaling and normalization operations implemented by the example choice forecasting calibration procedures 400 and/or 1000 to calibrate choice probabilities and segment weights operate to preserve the relative contributions between each pair of population segments before and after calibration to each choice share corresponding to each possible alternative. Additionally, the particular scaling and normalization operations implemented by the example choice forecasting calibration procedures 400 and/or 1000 to calibrate choice probabilities and segment weights operate to ensure that population segments having high choice probabilities associated with alternatives having higher target (or calibrated) choice shares than uncalibrated choice shares and low choice probabilities associated with alternatives having lower target (or calibrated) choice shares than uncalibrated choice shares (e.g., “in sync” population segments) will see an increase in their calibrated segment weights relative to their uncalibrated segment weights. Conversely, the particular scaling and normalization operations implemented by the example choice forecasting calibration procedures 400 and/or 1000 to calibrate choice probabilities and segment weights operate to ensure that population segments having low choice probabilities associated with alternatives having higher target (or calibrated) choice shares than uncalibrated choice shares and high choice probabilities associated with alternatives having lower target (or calibrated) choice shares than uncalibrated choice shares (e.g., “out of sync” population segments) will see a decrease in their calibrated segment weights relative to their uncalibrated segment weights.

FIG. 11 is a block diagram of an example computer 1100 capable of implementing the apparatus and methods disclosed herein. The computer 1100 can be, for example, a server, a personal computer, a personal digital assistant (PDA), an Internet appliance, a DVD player, a CD player, a digital video recorder, a personal video recorder, a set top box, or any other type of computing device.

The system 1100 of the instant example includes a processor 1112 such as a general purpose programmable processor. The processor 1112 includes a local memory 1114, and executes coded instructions 1116 present in the local memory 1114 and/or in another memory device. The processor 1112 may execute, among other things, the machine readable instructions represented in FIGS. 4 through 8. The processor 1112 may be any type of processing unit, such as one or more microprocessors from the Intel® Centrino® family of microprocessors, the Intel® Pentium® family of microprocessors, the Intel® Itanium® family of microprocessors, and/or the Intel XScale® family of processors. Of course, other processors from other families are also appropriate.

The processor 1112 is in communication with a main memory including a volatile memory 1118 and a non-volatile memory 1120 via a bus 1122. The volatile memory 1118 may be implemented by Static Random Access Memory (SRAM), Synchronous Dynamic Random Access Memory (SDRAM, Dynamic Random Access Memory (DRAM), RAMBUS Dynamic Random Access Memory (RDRAM) and/or any other type of random access memory device. The non-volatile memory 1120 may be implemented by flash memory and/or any other desired type of memory device. Access to the main memory 1118, 1120 is typically controlled by a memory controller (not shown).

The computer 1100 also includes an interface circuit 1124. The interface circuit 1124 may be implemented by any type of interface standard, such as an Ethernet interface, a universal serial bus (USB), and/or a third generation input/output (3GIO) interface.

One or more input devices 1126 are connected to the interface circuit 1124. The input device(s) 1126 permit a user to enter data and commands into the processor 1112. The input device(s) can be implemented by, for example, a keyboard, a mouse, a touchscreen, a track-pad, a trackball, an isopoint and/or a voice recognition system.

One or more output devices 1128 are also connected to the interface circuit 1124. The output devices 1128 can be implemented, for example, by display devices (e.g., a liquid crystal display, a cathode ray tube display (CRT)), by a printer and/or by speakers. The interface circuit 1124, thus, typically includes a graphics driver card.

The interface circuit 1124 also includes a communication device such as a modem or network interface card to facilitate exchange of data with external computers via a network (e.g., an Ethernet connection, a digital subscriber line (DSL), a telephone line, coaxial cable, a cellular telephone system, etc.).

The computer 1100 also includes one or more mass storage devices 1130 for storing software and data. Examples of such mass storage devices 1130 include floppy disk drives, hard drive disks, compact disk drives and digital versatile disk (DVD) drives. The mass storage device 1130 may implement the example storage unit 135, the example input data storage unit 205, the example segment weight storage unit 235, the example choice probability storage unit 240 and/or the example choice share storage unit 245. Alternatively, the volatile memory 1118 may implement the example storage unit 135, the example input data storage unit 205, the example segment weight storage unit 235, the example choice probability storage unit 240 and/or the example choice share storage unit 245.

As an alternative to implementing the methods and/or apparatus described herein in a system such as the device of FIG. 11, the methods and or apparatus described herein may be embedded in a structure such as a processor and/or an ASIC (application specific integrated circuit).

Finally, although certain example methods, apparatus and articles of manufacture have been described herein, the scope of coverage of this patent is not limited thereto. On the contrary, this patent covers all methods, apparatus and articles of manufacture fairly falling within the scope of the appended claims either literally or under the doctrine of equivalents.

1. A method to calibrate a choice forecasting system configured to determine choice shares representing probabilities that alternatives from a plurality of alternatives will be chosen by population segments in an overall population, the method comprising:
obtaining market research data to determine a plurality of choice probabilities and a plurality of segment weights, each choice probability representing a probability that a respective population segment will choose a respective alternative from the plurality of alternatives and each segment weight representing a weight of a respective population segment in the overall population;
performing a calibration procedure to calibrate the plurality of choice probabilities and the plurality of segment weights, the calibration procedure configured to preserve before and after calibration relative contributions of a pair of population segments to a first choice share corresponding to a first alternative, wherein the first choice share for the first alternative is determinable from the plurality of segment weights and a subset of the plurality of choice probabilities corresponding to the first alternative; and
storing a plurality of calibrated choice probabilities and a plurality of calibrated segment weights for use by the choice forecasting system to output a choice forecast.

2. (canceled)

3. A method as defined in claim 1 wherein the calibration procedure is further configured to preserve before and after calibration all relative contributions of all possible pairs of population segments to the first choice share corresponding to the first alternative.

4. A method as defined in claim 3 wherein the calibration procedure is further configured to preserve before and after calibration all relative contributions of all possible pairs of population segments to each of a plurality of choice shares corresponding respectively to each of the plurality of alternatives.

5. A method as defined in claim 1 wherein the relative contributions of the pair of population segments to the first choice share corresponding to the first alternative are preserved before and after calibration when a first ratio of uncalibrated weighted choice probabilities corresponding to each of the pair of population segments choosing the first alternative is substantially equal to a second ratio of calibrated weighted choice probabilities corresponding to the pair of population segments choosing the first alternative.

6. (canceled)

7. A method as defined in claim 1 wherein performing the calibration procedure comprises scaling a first choice probability corresponding to a first population segment selecting the first alternative by a ratio of a first target choice share corresponding to the first alternative and a first uncalibrated choice share corresponding to the first alternative.

8. A method as defined in claim 7 wherein performing the calibration procedure further comprises normalizing the first scaled choice probability by a sum of scaled choice probabilities, each scaled choice probability included in the sum corresponding to the first population segment selecting a respective alternative from the plurality of alternatives.

9. A method as defined in claim 1 wherein performing the calibration procedure comprises:
scaling each particular choice probability in the plurality of choice probabilities by a respective ratio of a target choice share and an uncalibrated choice share, both the target choice share and the uncalibrated choice share corresponding to a particular alternative represented by the particular choice probability; and
normalizing each particular scaled choice probability by a sum of all scaled choice probabilities corresponding to a particular population segment represented by the particular scaled choice probability.

10. A method as defined in claim 1 wherein performing the calibration procedure comprises scaling a first segment weight corresponding to a first population segment by a sum of scaled choice probabilities, each scaled choice probability included in the sum determined by scaling a respective choice probability by a respective scale factor, the respective choice probability corresponding to the first population segment selecting a respective alternative from the plurality of alternatives, and the respective scale factor corresponding to a ratio of a respective target choice share and a respective uncalibrated choice share corresponding to the respective alternative.

11. A method as defined in claim 10 wherein performing the calibration procedure further comprises scaling each segment weight by a respective sum of scaled choice probabilities.

12. A method as defined in claim 1 further comprising providing a plurality of uncalibrated choice probabilities, a plurality of uncalibrated segment weights, a plurality of uncalibrated choice shares and a plurality of target choice shares to the calibration procedure, and wherein the calibration procedure operates to determine the plurality of calibrated choice probabilities and the plurality of calibrated segment weights based on the provided plurality of uncalibrated choice probabilities, plurality of uncalibrated segment weights, plurality of uncalibrated choice shares and plurality of target choice shares.

13. A method as defined in claim 1 wherein the plurality of choice probabilities are determined from a multinomial logit model and wherein the calibration procedure operates to adjust a plurality of utilities used by the multinomial logit model.

14. (canceled)

15. (canceled)

16. (canceled)

17. (canceled)

18. An apparatus to calibrate an automated choice forecasting system, the apparatus comprising:
a choice probability calibrator implemented at least in part by hardware or at least one processor to calibrate a plurality of choice probabilities, each choice probability representing a probability that a respective population segment will choose a respective alternative from a plurality of alternatives; and
a segment weight calibrator implemented at least in part by hardware or at least one processor to calibrate a plurality of segment weights, each segment weight representing a weight of a respective population segment in an overall population, wherein the choice probability calibrator and the segment weight calibrator operate to preserve before and after calibration ratios of choice probabilities weighted by respective segment weights, each ratio corresponding to any pair of population segments choosing a same alternative.

19. An apparatus as defined in claim 18 wherein the choice probability calibrator comprises:
a choice probability scaler to scale a particular choice probability in the plurality of choice probabilities by a respective ratio of a target choice share and a uncalibrated choice share, both the target choice share and the uncalibrated choice share corresponding to a particular alternative represented by the particular choice probability; and
a choice probability normalizer to normalize a particular scaled choice probability by a sum of all scaled choice probabilities corresponding to a particular population segment represented by the particular scaled choice probability.

20. An apparatus as defined in claim 18 wherein the segment weight calibrator is configured to scale a particular segment weight corresponding to a particular population segment by a sum of scaled choice probabilities, each scaled choice probability included in the sum determined by scaling a respective choice probability by a respective scale factor, the respective choice probability corresponding to the particular population segment selecting a respective alternative from the plurality of alternatives, and the respective scale factor corresponding to a ratio of a respective target choice share and a respective uncalibrated choice share corresponding to the respective alternative.

21. (canceled)

22. (canceled)

23. A system to calibrate an automated choice forecasting system, the system comprising:
a choice forecasting calibration unit to:
scale and normalize a plurality of uncalibrated choice probabilities to determine a respective plurality of calibrated choice probabilities, each choice probability representing a probability that a respective population segment will choose a respective alternative from a plurality of alternatives; and
scale a plurality of uncalibrated segment weights to determine a respective plurality of calibrated segment weights, each segment weight representing a weight of a respective population segment in an overall population; and
a memory unit to store the plurality of calibrated choice probabilities and the plurality of calibrated segment weights for use by the automated choice forecasting system to output a choice forecast.

24. A system as defined in claim 23 wherein the choice forecasting calibration unit is configured to scale and normalize the plurality of uncalibrated choice probabilities based on a plurality of uncalibrated choice shares and a respective plurality of target choice shares, each choice share representing a probability that an individual selected randomly from the overall population chooses a particular alternative from the plurality of alternatives corresponding to the choice share.

25. A system as defined in claim 24 wherein the plurality of uncalibrated choice shares are determined using the plurality of uncalibrated choice probabilities and the plurality of uncalibrated segment weights, and wherein the plurality of target choice shares are determined from market research data.

26. A system as defined in claim 24 wherein the choice forecasting calibration unit is configured to scale the plurality of uncalibrated segment weights based on a plurality of scaled choice probabilities determined during determination of the plurality of calibrated choice probabilities.

27. A system as defined in claim 23 wherein the choice forecast output by the automated choice forecasting system is used to determine whether to at least one of commence, halt or modify launching of at least one of a new product or new service.

28. A method to calibrate a choice forecasting system configured to determine choice shares representing probabilities that alternatives from a plurality of alternatives will be chosen by population segments in an overall population, the method comprising:
obtaining market research data to determine a plurality of choice probabilities and a plurality of segment weights, each choice probability representing a probability that a respective population segment will choose a respective alternative from the plurality of alternatives and each segment weight representing a weight of a respective population segment in the overall population;
performing a calibration procedure configured to preserve before and after calibration relative contributions of first and second population segments to a first choice share corresponding to a first alternative, the calibration procedure comprising:
determining a first scaled choice probability by scaling a first choice probability corresponding to the first population segment selecting the first alternative by a ratio of a first target choice share and a first uncalibrated choice share, the first target choice share corresponding to the first alternative and estimated from the market research data, and the first uncalibrated choice share corresponding to the first alternative and determinable from the plurality of segment weights and a subset of the plurality of choice probabilities corresponding to the first alternative;
normalizing the first scaled choice probability by a first sum of first scaled choice probabilities, each first scaled choice probability included in the first sum corresponding to the first population segment selecting a respective alternative from the plurality of alternatives;
scaling a first segment weight corresponding to the first population segment by the first sum of the first scaled choice probabilities
determining a second scaled choice probability by scaling a second choice probability corresponding to the second population segment selecting the first alternative by a ratio of the first target choice share and the first uncalibrated choice share;
normalizing the second scaled choice probability by a second sum of second scaled choice probabilities, each second scaled choice probability included in the second sum corresponding to the second population segment selecting a respective alternative from the plurality of alternatives; and
scaling a second segment weight corresponding to the second population segment by the second sum of the second scaled choice probabilities; and
storing a plurality of calibrated choice probabilities and a plurality of calibrated segment weights for use by the choice forecasting system to output a choice forecast used to determine whether to at least one of commence, halt or modify launching of at least one of a new product or new service.
